(19) United States
(12) Patent Application Publication
(10) Pub. No.: US 2011/0203491 A1
(43) Pub. Date: Aug. 25, 2011

(54) SYSTEM AND METHOD FOR AN IMPROVED PALLET

(75) Inventor: GAREN POE, Scottsdale, AZ (US)

(73) Assignee: GAVEN POE, Scottsdale, AZ (US)

(21) Appl. No.: 13/033,194

(22) Filed: Feb. 23, 2011

Related U.S. Application Data
(60) Provisional application No. 61/308,100, filed on Feb. 25, 2010.

(51) Int. Cl. B65D 19/38; B23P 11/00

(52) U.S. Cl. 108/42; 108/57.32; 29/464

(57) ABSTRACT

The disclosure relates to an improved pallet design that minimizes the retention of various harmful elements and has a simplified assembly which limits destructive alterations by incorporating a screw race.

### CROSS-REFERENCE TO RELATED APPLICATIONS

This application claims priority to, and the benefit of, U.S. Provisional Application Ser. No. 61/308,100 filed on Feb. 25, 2010, and entitled “System And Method For An Improved Pallet,” which is incorporated herein by reference in its entirety.

### FIELD

An improved pallet design that is quick and easy to assemble and disassemble, while resisting retention of harmful elements and includes easily replaceable parts.

### BACKGROUND

Wooden pallets are typically used to transport and/or store goods. However, wooden pallets are a significant problem in, for example, the shipping and food industry. Some exemplary problems associated with wooden pallets include the wood retaining bacteria and other spoils from current or previous shipments. In that regard, in order to use the wooden pallet with a new food product, the wooden pallet is inspected and thoroughly cleaned. Such inspection and cleaning often requires extensive resources including inspectors, inspection fees, chemicals, washing time and drying time. The inspection process may also result in loss of use of the pallets and delayed shipments due to wooden pallets being held up in customs for weeks. Moreover, wooden pallets often break and splinter, along with nails coming loose, thereby resulting in a lack of integrity and a safety hazard (in addition to potential puncturing or scratching of the goods). Wooden pallets also are susceptible to fire hazards and require the destruction of trees.

Existing aluminum pallets are welded and screwed together with individual holes. The existing aluminum pallets are limited to the holes provided, along with increased manufacturing time and expense. As such, a long-felt need exists to improve upon the materials and configuration of pallets, along with the method of assembly.

### SUMMARY OF THE INVENTION

The system generally comprises a pallet that includes a stringer that may be comprised of a material that minimizes or eliminates the retention of bacteria. The stringer also includes a screw race running along a portion of the stringer on a top mating surface and a bottom mating surface. The screw race retains a fastener at any point along the length of the stringer. The pallet may include a deck slat (which may comprise a material that minimizes or eliminates the retention of bacteria), at least one hole, a bottom surface, and a top surface. The slat's bottom surface may mate with the stringer's top mating surface. At least one hole may align with the screw race. A fastener may connect the deck slat to the first stringer by passing the fastener through the hole and mating the fastener with the two walls.

A method for assembling a pallet generally includes receiving a disassembled pallet having a stringer and a deck slat. The method may further include aligning a fastener hole in the deck slat with a screw race in the stringer. The method may also include inserting a fastener through the fastener hole and into the screw race. The method may also include applying a compressive force between the stringer and the decking by tightening the fastener.

A pallet stringer may also be used in other ways, such as for example, using an aluminum pallet stringer, having a screw race running along a portion of the stringer, as a parameter of a home deck structure. The method further including attaching wood decking to the pallet stringer by inserting a screw through a hole in the wood decking and into the screw race in the pallet stringer.

### BRIEF DESCRIPTION OF THE DRAWINGS

FIG. 1 illustrates a perspective view of a pallet, in accordance with an exemplary embodiment of the present invention;

FIG. 2 illustrates an end view of a deck slat, in accordance with an exemplary embodiment of the present invention;

FIG. 3A illustrates an end view of a stringer, in accordance with an exemplary embodiment of the present invention; and

FIG. 3B is an illustration of a section end view of a screw race, in accordance with an exemplary embodiment of the present invention.

### DETAILED DESCRIPTION

The detailed description of exemplary embodiments herein makes reference to the accompanying drawings, which show exemplary embodiments by way of illustration and its best mode. While these exemplary embodiments are described in sufficient detail to enable those skilled in the art to practice the invention, it should be understood that other embodiments may be realized and that logical, chemical and mechanical changes may be made without departing from the spirit and scope of the invention. Thus, the detailed description herein is presented for purposes of illustration only and not of limitation. For example, the steps recited in any of the method or process descriptions may be executed in any order and are not necessarily limited to the order presented. Moreover, many of the functions or steps may be outsourced to or performed by one or more third parties. Furthermore, any reference to singular includes plural embodiments, and any reference to more than one component or step may include a singular embodiment or step. Also, any reference to attached, fixed, connected or the like may include permanent, removable, temporary, partial, full and/or any other possible attachment option. Additionally, any reference to without contact (or similar phrases) may also include reduced contact or minimal contact.

The present invention includes a pallet comprised of a material and constructed in a way that does not retain (or minimal retention of) various harmful elements such as bacteria and other spoils. The invention also contemplates a pallet that is comprised of a material and constructed in a way that allows for easier and quicker cleaning of the pallet. The material may be comprised of any metal, composite, non-wood containing material, non-porous material, a material with minimal pores and/or other similar composition. In one embodiment, the pallet is comprised of aluminum.

Aluminum pallets are non-porous (or minimal pores), thereby eliminating or reducing the need for inspection of various harmful elements. Aluminum pallets can be steam-cleaned. Aluminum pallets are also lighter in weight, but stronger in integrity. A shipping unit may charge by weight or limit the amount of weight per shipment, so the lighter weight allows more products to be shipped and at lower cost. Aluminum pallets do not require or need wood parts, so no trees are destroyed in the manufacturing of aluminum pallets. The pallet discussed herein is superior to other pallets due to its simplified design and related assembly process.

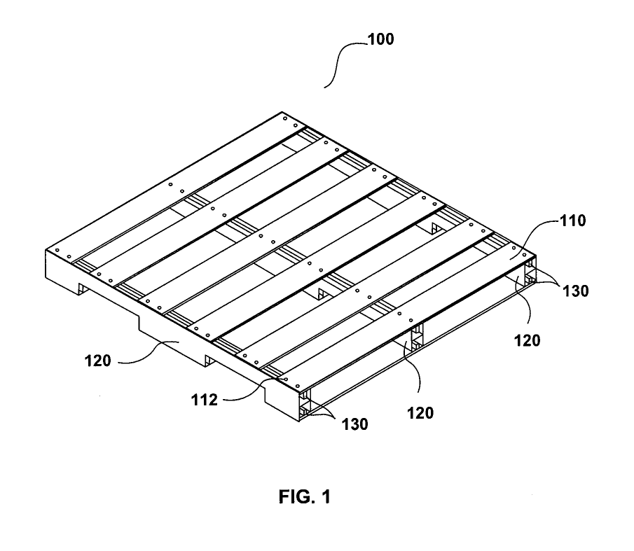

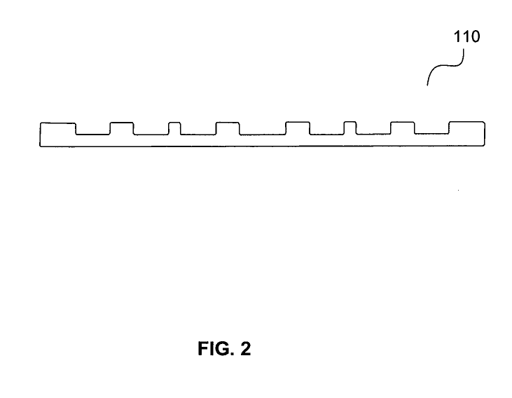

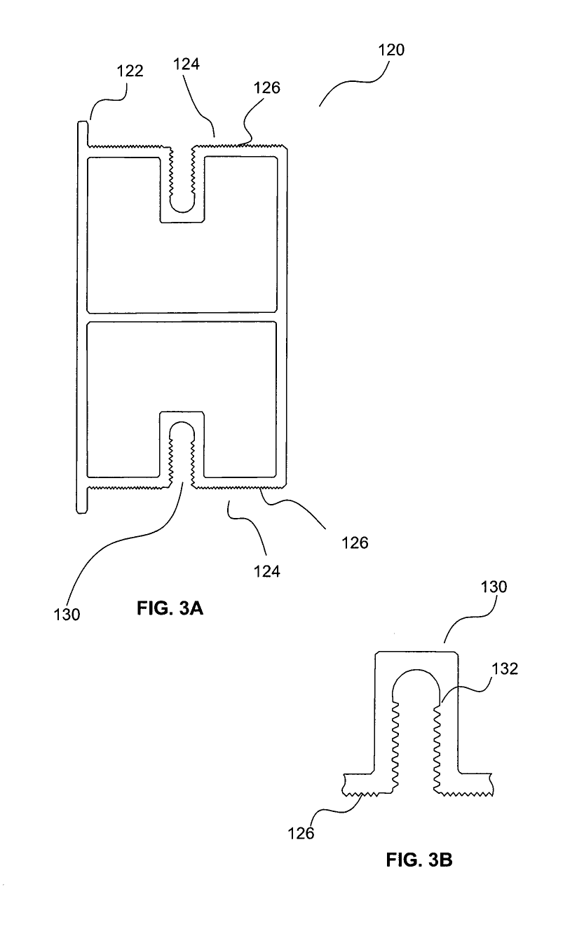

Referring to FIG. 1, a pallet 100 may include a stringer 120, a deck slat 110, and fastener 112. Referring to FIG. 3A, stringer 120 (e.g. the main rafter) may consist of a lightweight but heavy-duty extruded construction. A mating surface 124 of stringer 120 may incorporate serrations and/or any type of friction surface 126. Friction surface 126 may reduce slipping or create grab for any item (e.g. slat 110) in contact with the surface. Such interaction helps to keep the contacting item tight and locked in position. Stringer 120 may also incorporate a lip 122. Lip 122 may run a portion or the full length of an edge of mating surface 124. Lip 122 may further retain slat 110 and maintain the slat in a substantially square position relative to Stringer 120. This may further maintain pallet 100 as substantially true and square. The lip may be, for example, ¼″ in height. In other embodiments, Stringer 120 may have no lips allowing a slat to cross the entire stringer, such as for example a center stringer on a pallet.

Referring to FIGS. 1 and 3A, stringer 120 may include a feature configured to receive and retain a fastener. In one example, the feature may be a screw race 130. Screw race 130 may be a channel which may run fully or partially along the length of stringer 120. Furthermore, screw race 130 may be sized to receive and engage a fastener along the channel walls. For example, the channel wall may be sized such that a ¼-20 screw would positively engage and/or interfere with the channel walls. The fastener would not be removable without applying torque to and/or destroying the fastener. In other examples, the channel walls may have a thread pattern 132 which are operable to engage the screw threads. Thread pattern 132 may be specifically sized to engage an ordinary screw such as a 1/-20 screw. The screw race may be used in place of and/or in conjunction with holes for quick assembly and ease of replacement parts. The screw race reduces or eliminates the need for drilling holes. As screw race 130 runs a potion of or the entire length of stringer 120. Screw race 130 allows the customer the ability to position the slats in any desired orientation with little effort (e.g. without drilling new fastener holes). In other embodiments, screw race 130 may be a channel that retains one or more nuts, such that a bolt can be threaded into the nut and the combination may serve to retain a slat. Through these examples it is illustrated that a screw race may limit the destructive alteration to a pallet (e.g. drilling new holes) when moving or installing new pallets. As such, any screw race that limits the destructive alteration to a pallet when installing new slats is contemplated herein.

The simplicity of the assembly allows the shipment of knocked down pallets to the customer, for customer assembly. In one embodiment, the pallets can be assembled by the manufacturer or third parties. For example, a customer may receive a disassembled pallet having one or more stringers 120 and deck slats 110. The customer may use any appropriately sized fastener (e.g. ¼-20 screw) purchased at any hardware retailer. The customer may align the screw hole in the deck slat with the screw race in the stringer. The customer may insert the fastener through the fastener hole and into the screw race. The customer may torque the fastener into the screw race, thus applying a compressive force between the stringer and the decking by continuing to tighten the fastener.

The pallet components may be manufactured by any process known in the art. In exemplary embodiments, some or all of the components (or any portion thereof) are aluminum extrusions, cast, machined and/or any single or combination of manufacturing processes may be used. In various embodiments, the components can be manufactured in any length, shape, and/or size. In one embodiment, the extrusions are 24′ lengths and can be cut to size. Within a matter of minutes of being cut to size, the pallets may be assembled. It is also possible to manufacture a pallet any size consistent with the length of the manufactured components. For example, a customer could have a 24′ pallet. Furthermore, all parts may be mass produced, replaceable and interchangeable.

In accordance with various embodiments, the pallet components may be used for other structure projects. For example, stringer 120 of the present invention may be used for wooden decks on houses. The perimeter of the deck may include stringer 120. Aluminum posts may mate with one mating surface on the screw race of stringer 120 and then support the stringer from the ground. Decking (e.g., wood decking) may then be screwed into the screw race of stringer 120. Such a configuration may partially or fully eliminate rot and termites infestation from the ground. In various other embodiments, aluminum slats may also be incorporated in the deck.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the invention. Moreover, where a phrase similar to “at least one of A, B, or C” is used in the specification or claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

We claim:

1. A pallet comprising:
a first stringer comprising a material that minimizes the retention of bacteria, a screw race running along a portion of the stringer, a top mating surface, and a bottom mating surface, wherein the screw race retains a fastener at a plurality of points along the length of the stringer;
a deck slat comprising a material that minimizes the retention of bacteria, at least one hole, a bottom surface, and a top surface, wherein the bottom surface mates with the stringer top mating surface, wherein the at least one hole aligns with the screw race; and
a fastener comprising a material that minimizes the retention of bacteria connecting the deck slat to the first stringer by passing the fastener through the at least one hole and mating the fastener with the two walls.

2. The pallet of claim 1, wherein the first stringer is symmetric such that deck slats fasten to both the top mating surface and the bottom mating surface.

3. The pallet of claim 1, wherein the material that minimizes the retention of bacteria is aluminum.

4. The pallet of claim 1, wherein the top mating surface and bottom mating surface comprise a textured surface.

5. The pallet of claim 1, further including at least three stringers, wherein the first stringer is one of two outside stringers, and wherein a third stringer is a center stringer.

6. The pallet of claim 5, wherein outside stringers have a retaining lip and center stringers do not a have a retaining lip, wherein an end of each deck slat mates with the lip maintaining the each of the deck slats square relative to the stringer.

7. A method for assembling a pallet comprising:
receiving a disassembled pallet having a stringer and a deck slat;
aligning a fastener hole in the deck slat with a screw race in the stringer;
inserting a fastener through the fastener hole and into the screw race; and
applying a compressive force between the stringer and the decking by tightening the fastener.

8. A method for using a pallet stringer comprising using an aluminum pallet stringer, having a screw race running along a portion of the stringer, as a parameter of a home deck structure, wherein wood decking is attached to the pallet stringer by inserting a screw through a hole in the wood decking and into the screw race in the pallet stringer.
